(19) United States
(12) Patent Application Publication
(10) Pub. No.: US 2023/0113780 A1
(43) Pub. Date: Apr. 13, 2023

(54) LASER ROBOT SYSTEM

(71) Applicant: FANUC CORPORATION, Yamanashi (JP)

(72) Inventors: Tatsuya SUZUKI, Yamanashi (JP); Masahiro HONDA, Yamanashi (JP)

(73) Assignee: FANUC CORPORATION, Yamanashi (JP)

(21) Appl. No.: 17/906,576

(22) PCT Filed: Jun. 21, 2021
(86) PCT No.: PCT/JP2021/023387

§ 371 Date: Sep. 16, 2022

(30) Foreign Application Priority Data
Jun. 26, 2020 (JP) 2020-110129

(51) Int. Cl. B23K 26/082; B25J 9/16

(52) U.S. Cl. CPC B23K 26/082; B25J 9/1674; B25J 3/00

(57) ABSTRACT

The purpose of the present invention is to construct a system in which a robot cell receives output from a laser oscillator separate from the robot cell and is irradiated with a laser beam, wherein the need for complicated wiring is obviated without introducing a safety support system such as a safety PLC. In the present invention, a safety signal from a robot cell is communicated from a robot controller to a laser oscillator, where the robot controller serves as a master unit and the laser oscillator serves as a slave unit, thereby making it possible to obviate the need for numerous wires and to carry out installation such that wiring is uncomplicated.

### TECHNICAL FIELD

The present invention relates to a laser robot system, and particularly relates to a laser robot system in which a plurality of robot cells share one laser oscillator.

### BACKGROUND ART

Conventionally, among safety control systems each for a plurality of robot cells, such a safety control system has been known in which a single monitoring device monitors a plurality of devices, and stops operation of one of the devices when an abnormality is detected in the one of the devices. Patent Document 1 describes a safety control system provided with a plurality of unit devices, including a safety control device, which are coupled to each other via a network. The safety control device is configured to determine whether there is an abnormality in an operation state in one of the unit devices based on state data and determination criteria. When it is determined that there is an abnormality, the safety control device causes the one of the unit devices to stop its operation, and directly sends, via the network, monitoring data representing a result of the determination to the other designated one(s) of the unit devices.

Patent Document 1: PCT International Publication No. WO2015/132938

### DISCLOSURE OF THE INVENTION

### Problems to be Solved by the Invention

Patent Document 1 describes one where the safety control device monitors only the unit devices such as a plurality of robot cells. However, in a system where a plurality of robot cells each configured to perform laser irradiation by receiving output of a laser oscillator that is separate from the robot cells to perform irradiation with laser beams for a processing task, in order to cause one of the robot cells to safely stop laser irradiation when the safety control device has detected an abnormality in the one of the robot cells, it is necessary to stop both operation of the robot cells and output of the laser oscillator to the one of the robot cells, making the safety system complicated. Then, in order to construct the safety system, it is necessary to input input-and-output (IO) signals, through hard-wires, to both the laser oscillator and the robot controller. Therefore, numerous wires are required, resulting in complicated wiring work.

Particularly, in a system where a plurality of robot cells share one laser oscillator, wires for safety signals increase in number in accordance with the number of the robot cells, resulting in further complicated wiring work, compared with a case where a laser oscillator and a robot cell form a one-by-one relationship.

Note that, although it is possible to reduce wires in number by utilizing a safety network (conforming to a safe communication standard such as PROFIsafe or CIP Safety), it is necessary to introduce a safety support system such as a safety programmable logic controller (PLC), which is disadvantageous in terms of cost and maintenance.

Therefore, in systems where irradiation with laser beams is performed by robot cells as the robot cells receive output from a laser oscillator that is separate from the robot cells, what is demanded is to construct such a system that does not require complicated wiring work and does not require introduction of a safety support system such as a safety PLC. Means for Solving the Problems

To solve the issue described above, a laser robot system according to the present disclosure is a laser robot system including: a plurality of robot cells each including a laser irradiation device; and a laser oscillator provided separately from the robot cells. The robot cells are provided with robot controllers, and each of the robot controllers is individually associated with a corresponding one of the robot cells and is configured to monitor and control operation of the corresponding one of the robot cells. The robot controller serves as a master unit. The laser oscillator serves as a slave unit. The robot controller communicates a signal sent from the corresponding one of the robot cells to the laser oscillator.

### Effects of the Invention

With the laser robot system according to the present disclosure, the robot controller serves as the master unit, the laser oscillator serves as the slave unit, and the robot controller communicates a safety signal sent from the corresponding one of the robot cells to the laser oscillator. Therefore, the system does not require numerous wires, resulting in less complicated wiring work. Then, it is not necessary to introduce a safety support system such as a safety PLC, resulting in advantageous effects in terms of cost and maintenance.

### BRIEF DESCRIPTION OF THE DRAWINGS

FIG. 1 is a configuration diagram of a conventional laser robot system;

FIG. 2 is a view illustrating how laser is transmitted from a laser oscillator, via fiber-optic cables, to robot cells;

FIG. 3 is a configuration diagram of a configuration of a conventional laser robot system in which Ethernet cables are used for connections to reduce wires in number;

FIG. 4 is a view illustrating a configuration diagram of a laser robot system according to the present disclosure; and

FIG. 5 is a view illustrating a flow of operation in the laser robot system according to the present disclosure.

### PREFERRED MODE FOR CARRYING OUT THE INVENTION

Embodiments of the present disclosure will now be described herein in detail with reference to the accompanying drawings.

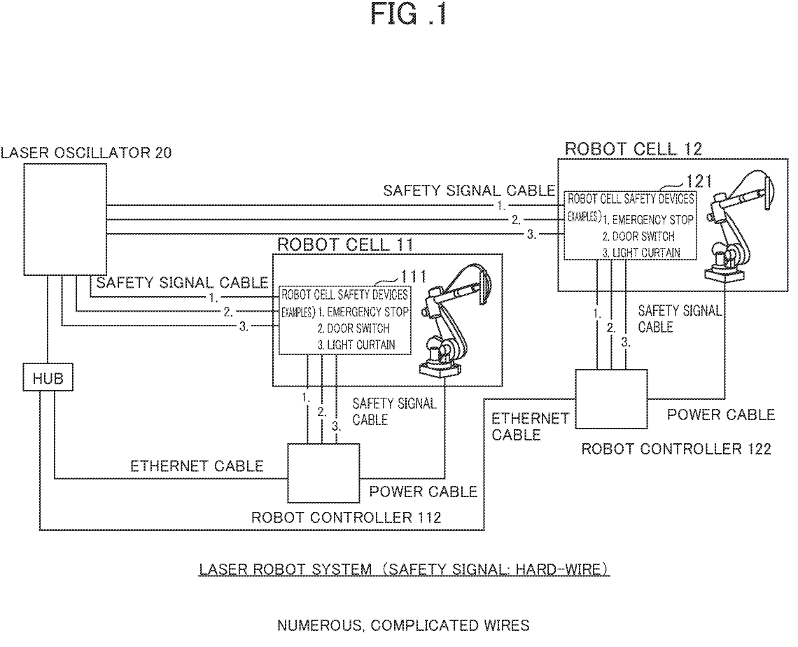

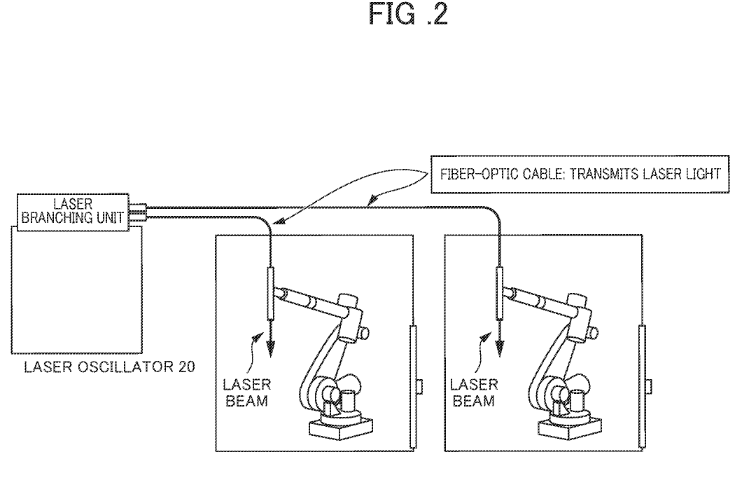

FIG. 1 illustrates a conventional laser robot system. In each of robot cells 11, 12, there is an articulated type robot having an articulated arm such as a six-axis vertical articulated arm or a four-axis vertical articulated arm. A laser irradiation device is attached at a front end of the articulated arm. As illustrated in FIG. 2, laser is transmitted from a laser oscillator 20, via fiber-optic cables for high output laser transmission, to the robot cells 11, 12. The laser oscillator 20 and the robot cells 11, 12 are installed separately by taking into account limitations in installation location and ease of maintenance. In each of the robot cells 11, 12, laser is emitted from a front end of a processing head to perform laser processing. The robot cells 11, 12 respectively include devices such as devices into which robot cell safety devices 111, 121 are respectively built or devices such as safety light curtains respectively configured to detect that an operator enters a corresponding one of the robot cells 11, 12, and are in communication with robot controllers 112, 122 and the laser oscillator 20. The robot controllers 112, 122 are respectively coupled, with power cables, to the robot cells 11, 12, and are coupled, with safety signal cables, to the robot cell safety devices 111, 121 of the robot cells 11, 12. The safety signal cables further couple the robot cell safety devices 111, 121 and the laser oscillator 20 to each other. The robot cell safety devices 111, 121, the robot controllers 112, 122, and the laser oscillator 20 are thus coupled to each other with the safety signal cables, sending to and receiving from each other signals pertaining to (1) emergency stop, (2) door switch, and (3) light curtain. The signals pertaining to (1) emergency stop are signals used to stop the whole system in an urgent manner, and also to stop operation of the robots and output of laser. The signals pertaining to (2) door switch are signals indicating opened and closed states of doors of the robot cells. When the door is in the opened state, output of laser is prohibited. The signals pertaining to (3) light curtain are signals used to stop the system when it is detected that an operator has entered (and is present in) a dangerous zone, and also to stop operation of the robots and output of laser.

The robot controllers 112, 122 each include a processing unit (CPU) including a microprocessor and a memory member such as random access memory (RAM), read-only memory (ROM), electrically erasable programmable read-only memory (EEPROM), or flash memory. The robot controllers 112, 122 each send, when detecting an abnormality in a corresponding one of the robot cells 11, 12, an emergency stop signal, via the safety signal cables, to a corresponding one of the robot cell safety devices 111, 121 and the laser oscillator 20 to stop both laser irradiation in the corresponding one of the robot cells 11, 12 and oscillation operation of the laser oscillator to secure safety. The robot controllers 112, 122 and the laser oscillator 20 are coupled to each other with the Ethernet cables via a hub to perform I/O communications and data communications.

As described above, in the conventional laser robot system, the safety signal cables are required, in addition to the power cables and the Ethernet cables, among the robot cell safety devices 111, 121, the robot controllers 112, 122, and the laser oscillator 20. Particularly, when the plurality of robot cells 11, 12 share the laser oscillator 20, numerous wires are required. That is, conventionally, wires are complicated, inefficiently resulting in less ease of use.

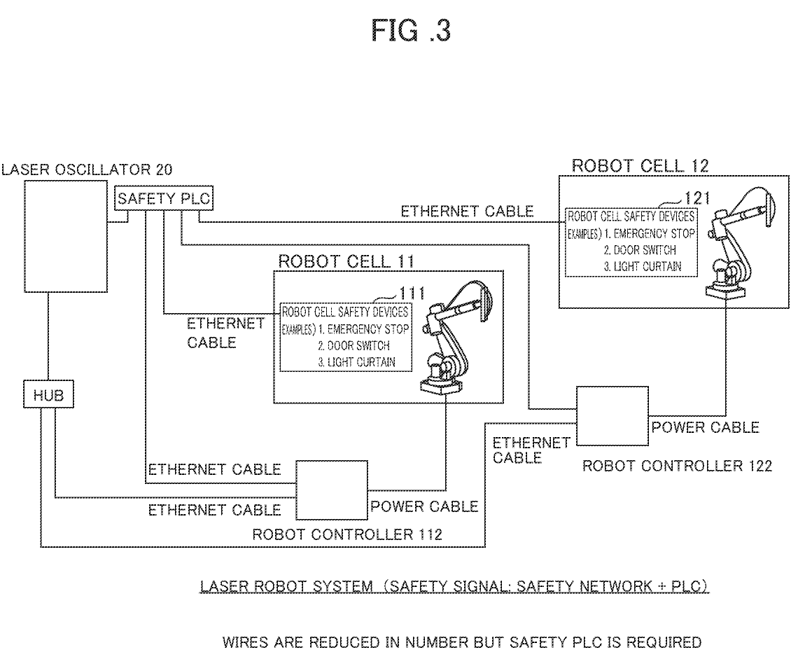

FIG. 3 illustrates a laser robot system where safety signal cables that have been seen in the conventional laser robot systems are eliminated, but the robot cell safety devices 111, 121, the robot controllers 112, 122, and the laser oscillator 20 are coupled to each other with Ethernet cables to reduce wires in number. What differs from that illustrated in FIG. 1 is that Ethernet cables are utilized, instead of safety signal cables, to couple the robot cell safety devices 111, 121, the robot controllers 112, 122, and the laser oscillator 20 to each other. However, the use of Ethernet cables has made it necessary to introduce a safety PLC. By introducing a safety PLC, it is possible to replace safety relays and other components with the safety PLC. The introduction achieves a simple circuit configuration with reduced wires in number. Replacement of relays and other components with an electronic device extends the life of components, enhancing reliability. Reduction in size of a control board and in number of components results in many advantages such as ease of calculating a performance level (PL) and ease of designing a laser robot system conforming to a safety standard. However, on the other hand, requiring a safety PLC results in disadvantages in terms of cost and maintenance.

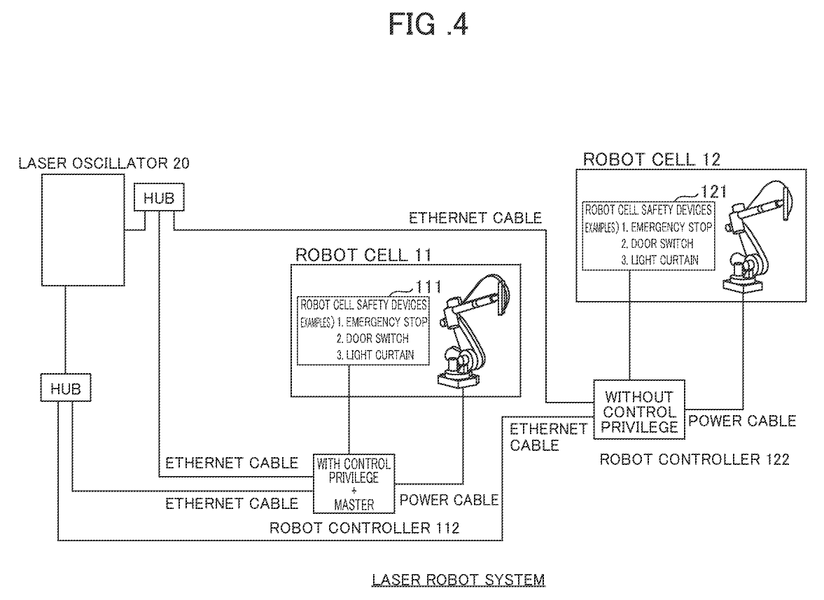

Next, FIG. 4 illustrates a laser robot system according to the present disclosure. In the laser robot system illustrated in FIG. 4, the most distinctive differences from the laser robot system illustrated in FIGS. 1 or 3 are, in communications between the robot controller 112 and the laser oscillator 20, the robot controller 112 serves as a master unit for communicating safety signals, and the laser oscillator 20 serves as a slave unit, making it possible to eliminate safety signal cables that have coupled the robot cell safety devices 111, 121, the robot controllers 112, 122, and the laser oscillator 20 to each other in the laser robot system illustrated in FIG. 1, and making the safety PLC in the laser robot system illustrated in FIG. 3 unnecessary.

The laser robot system according to the present disclosure illustrated in FIG. 4 will now be specifically described herein. Since a safety signal (an emergency stop signal, for example) generated from one of the robot cell safety devices 111, 121 when there is an abnormality in a corresponding one of the robot cells 11, 12 is inputted from the one of the robot cell safety devices 111, 121 into the corresponding one of the robot controllers 112, 122 to cause the one of the robot controllers 112, 122 to serve as the master unit for communicating the safety signal, and the laser oscillator 20 to serve as the slave unit, the safety signal is sent from the one of the robot controllers 112, 122, via the Ethernet cable, to the laser oscillator 20. Thereby, it has been possible to eliminate safety signal cables and a safety PLC, to make complicated wiring work unnecessary, to enhance ease of use, and to solve disadvantages in terms of cost and maintenance for the safety PLC.

The robot controllers 112, 122 are each allowed to be selected by switching whether a control privilege to serve as the master unit for controlling the laser oscillator 20 is granted. Only one of the robot controllers 112, 122, to which the control privilege for controlling the laser oscillator 20 is granted, serves as the master unit. Only a safety signal sent from the one of the robot controllers 112, 122, which serves as the master unit, is regarded as valid. A safety signal sent from the other one of the robot controllers 112, 122, which does not serve as the master unit, and to which the control privilege for controlling the laser oscillator 20 is not granted, is regarded as invalid.

In the laser robot system illustrated in FIG. 4, the robot controller 122 is selected by switching to not grant the control privilege for controlling the laser oscillator 20, and does not serve as the master unit. As such, even when an abnormality occurs in the robot cell 12, and a safety signal is sent from the robot controller 122 to the laser oscillator, laser oscillation operation of the laser oscillator 20 does not stop. In this case, even though laser irradiation operation in the robot cell 12 stops due to the signal sent from the robot controller 122, the laser oscillator 20 does not stop, and laser irradiation operation in the robot cell 11 continues.

On the other hand, when an abnormality occurs in the robot cell 11 in the laser robot system illustrated in FIG. 4, laser oscillation operation of the laser oscillator 20 stops due to a safety signal sent from the robot controller 112 to the laser oscillator 20 as the robot controller 112 for the robot cell 11 is granted with the control privilege (a master privilege) for the laser oscillator 20. As such, as laser irradiation operation in the robot cell 11 stops, and, even when no abnormality has occurred in the robot cell 12, laser irradiation operation in the robot cell 12 also stops, and the whole laser robot system at least temporarily stops.

Even when the plurality of robot cells 11, 12 share the laser oscillator 20, it is possible to make a selection by switching a master function (the control privilege for the laser oscillator 20) for either the robot controllers 112, 122, as described above, allowing the whole system to achieve a safety function making it possible to variously deal with an abnormal state within the system in accordance with the characteristics and usage situations of the robot cells 11, 12.

Furthermore, the master function (the control privilege for the laser oscillator 20) for either the robot controllers 112, 122 is not only achieved by the safety function when an abnormality occurs in one of the robot cells 11, 12 in the implementation example described above, for example, i.e., control of sending a safety signal to the laser oscillator 20, but also utilized in a system where utilization of the laser oscillator 20 is divided per a certain period of time in the plurality of robot cells 11, 12. In this system, for example, the master privilege (the control privilege for the laser oscillator 20) for either the two robot controllers 112, 122 is switched per a certain period of time, and, in a time slot, it is set that the robot controller 112 is granted with the master privilege, while the robot controller 122 is not granted with the master privilege, whereas, in another time slot, it is set that the robot controller 112 is not granted with the master privilege, while the robot controller 122 is granted with the master privilege. Then, when receiving an output command for laser oscillation from the robot controller 112 or 122, the laser oscillator 20 performs output of laser oscillation to only either the robot cell 11 or 12, which corresponds to the robot controller 112 or 122, which has received the output command for laser oscillation. Then, in the time slot where the robot controller 112 is granted with the master privilege, only a signal of a laser output command sent from the robot controller 112 to the laser oscillator 20 is regarded as valid, allowing only the robot cell 11 to utilize output of the laser oscillator 20 to perform laser irradiation, while a laser output command sent from the robot controller 122 that is not granted with the master privilege to the laser oscillator 20 is regarded as invalid, disallowing the robot cell 12 to perform laser irradiation. On the other hand, in the time slot where the robot controller 122 is granted with the master privilege, only the robot cell 12 is allowed to utilize output of the laser oscillator 20 to perform laser irradiation, while the robot cell 11 is disallowed to perform laser irradiation. As described above, it is possible to utilize the master function (the control privilege for the laser oscillator 20) for either the robot controllers 112, 122 in a system where laser output of the laser oscillator 20 is used and divided per a certain period of time between the robot cells 11, 12.

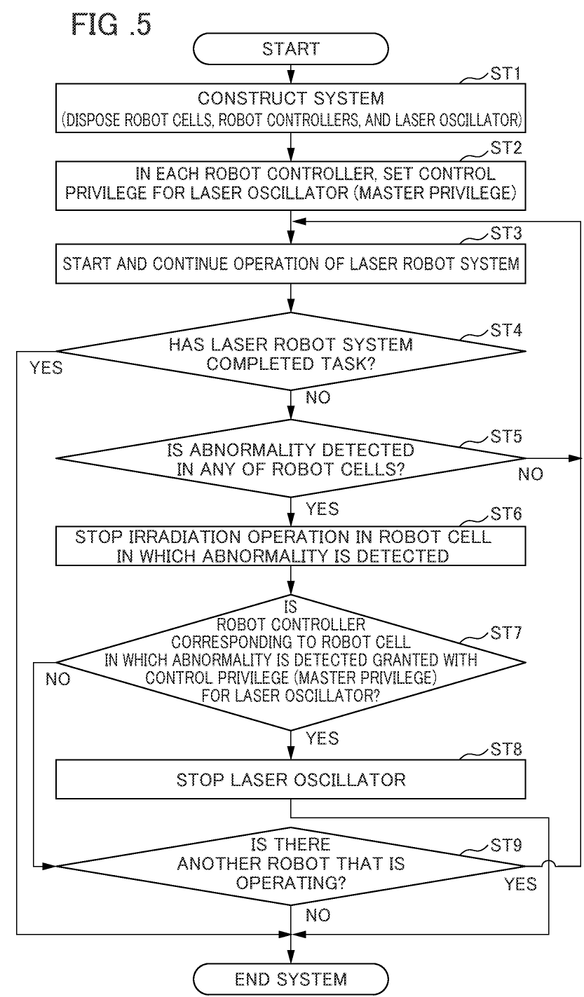

Operation of a safety control system by a robot laser system according to the present disclosure is illustrated in a flowchart in FIG. 5. As illustrated in FIG. 5, in order to construct a robot laser system, robot cells, robot controllers, and a laser oscillator are first disposed (Step ST1). A plurality of robot cells are disposed, and the plurality of robot cells share one laser oscillator. Furthermore, the robot controllers are provided to respectively correspond to the robot cells in a one-by-one manner.

Next, the control privilege for controlling the laser oscillator (the master privilege) is set in one of the robot controllers (Step ST2). When one of the robot controllers is not granted with the master privilege, a safety signal sent from the one of the robot controllers to the laser oscillator is regarded as invalid. After that, operation of the robot laser system starts and, furthermore, continues (Step ST3).

Then, it is determined whether the robot laser system has completed a laser processing task (Step ST4). When a result of determination is YES, i.e., the robot laser system has completed the laser processing task, the system ends, and this flow also ends. When a result of determination is NO, i.e., the robot laser system has not yet completed the laser processing task, and has still continuing the laser processing task, the flow proceeds to the next step, i.e., Step ST5.

At Step ST5, it is determined whether there is an abnormality detected in any of the robot cells. When a result of determination is YES, i.e., when there is an abnormality detected in any of the robot cells, irradiation operation in the robot cell in which the abnormality has been detected stops (Step ST6). The flow proceeds to the next step, i.e., Step ST7. It is then determined whether the robot controller for the robot cell in which the abnormality has been detected is granted with the control privilege for the laser oscillator (the master privilege). When a result of determination at Step ST5 is NO, i.e., when no abnormality is detected in any of the robot cells, the flow returns to Step ST3, operation of the robot system continues, waiting for completion.

At Step ST7, after an abnormality has been detected in any of the robot cells, it is determined whether the robot controller corresponding to the robot cell in which the abnormality has been detected is granted with the control privilege for the laser oscillator (the master privilege). When a result of determination is YES, i.e., the robot controller corresponding to the robot cell in which the abnormality has been detected is granted with the control privilege for the laser oscillator (the master privilege), oscillation operation of the laser oscillator stops (Step ST8). Then, as oscillation operation of the laser oscillator stops, it is impossible to perform laser irradiation in all the robot cells. Therefore, the whole laser robot system at least temporarily ends, and this flow also ends.

When a result of determination at Step ST7 is NO, i.e., the robot controller corresponding to the robot cell in which the abnormality has been detected is not granted with the control privilege for the laser oscillator (the master privilege), oscillation operation of the laser oscillator does not stop, and oscillation operation of the laser oscillator continues. Then, the flow proceeds to the next step, i.e., Step ST9.

At the next step, i.e., Step ST9, it is determined whether there is another robot cell that is operating. When a result of determination is YES, i.e., there is another robot cell that is operating, even though irradiation operation in the robot cell in which the abnormality has been detected has stopped, but the laser oscillator has not yet stopped, and laser irradiation operation in the other robot cell that is operating continues. Therefore, the flow returns to Step 3, the operation situation of the system as the whole laser robot system continues, waiting for completion of a task.

When a result of determination at Step ST9 is NO, i.e., there is no other robot cell that is operating, irradiation operation in the robot cell in which the abnormality has been detected has been stopped at Step ST6, and, furthermore, it is regarded that there is no other robot cell that is operating, there are no robots that are operating in the whole laser robot system. Therefore, the whole laser robot system at least temporarily ends, and this flow also ends.

Next, effects of the laser robot system according to the disclosed present invention will now be described herein. First of all, the basic effects indicating the core features of the laser robot system according to the disclosed present invention are that, as one of the robot controllers serves as the master unit, the laser oscillator serves as the slave unit, and a signal such as a safety signal sent from the corresponding one of the robot cells is communicated from the one of the robot controllers to the laser oscillator, it is possible to eliminate numerous wires that have been required conventionally, making it possible to solve such an issue on wiring designing that complicated wiring work has sacrificed ease of use. Furthermore, in addition to the effects, introduction of a safety support system such as a safety PLC has been unnecessary, resulting in improvements in terms of cost and maintenance, compared with conventional systems.

Furthermore, when one of the robot controllers has detected an abnormality in its corresponding one of the robot cells in the laser robot system according to the disclosed present invention, the one of the robot controllers causes laser irradiation in the corresponding one of the robot cells to stop, and causes oscillation operation of the laser oscillator to stop as the corresponding one of the robot controllers communicates a safety signal sent from the corresponding one of the robot cells to the laser oscillator. That is, since safety is secured by stopping both laser irradiation in the robot cells and oscillation operation of the laser oscillator, instead of securing safety by stopping either laser irradiation in the robot cells or oscillation operation of the laser oscillator, it is possible to more particularly enhance safety.

Furthermore, when the plurality of robot cells share one laser oscillator in the laser robot system according to the disclosed present invention, wiring work becomes further complicated, compared with a case where a robot cell corresponds to an oscillator in a one-by-one manner. Therefore, applying the laser robot system according to the present disclosure makes it possible to acquire further greater effects.

Furthermore, in the laser robot system according to the disclosed present invention, it is possible to select one of the robot controllers by switching whether the control privilege to serve as the master unit is granted, making it possible to regard only a safety signal sent from the one of the robot controllers, which is granted with the control privilege to serve as the master unit, as valid. With this configuration, when one of the robot controllers has been selected by switching so that the control privilege to serve as the master unit is not granted, and even when there is an abnormality detected in one of the robot cells, it is possible that the one of the robot controllers causes laser irradiation in the corresponding one of the robot cells, in which the abnormality has been detected, to stop, but causes the laser oscillator to not stop, making it possible to continue laser irradiation operation in the other one(s) of the robot cells sharing the laser oscillator. In a laser robot system including a plurality of robot cells, there are thus effects that it is possible to variously deal with an abnormal state within the system, as the whole system, in accordance with characteristics and usage situations of the robot cells.

Furthermore, as another application of the laser robot system according to the disclosed present invention, by regarding a signal communicated from one of the robot controllers to the laser oscillator as an output command signal for laser oscillation to one of the robot cells, which corresponds to the one of the robot controllers, and by switching whether the control privilege to serve as the master unit for the laser oscillator is granted per a certain period of time, it is possible to achieve a system where output of laser oscillation by the laser oscillator is divided and used per a certain period of time among the plurality of robot cells. Such a system as described above has the effect that the laser oscillation output of the laser oscillator can be more efficiently divided and used by the plurality of robot cells.

The embodiments have been described with regard to implementation of the present invention. However, the present invention is not limited to these embodiments. It is of course possible to implement the present invention in various aspects within a range without departing from the scope of the present invention.

### EXPLANATION OF REFERENCE NUMERALS

11, 12 Robot cell
111, 121 Robot cell safety device
112, 122 Robot controller
20 Laser oscillator

1. A laser robot system comprising:
a plurality of robot cells each including a laser irradiation device; and
a laser oscillator provided separately from the robot cells,
the plurality of robot cells being provided with robot controllers, each of the robot controllers being individually associated with a corresponding one of the robot cells and being configured to monitor and control operation of the corresponding one of the robot cells,
one of the robot controllers serving as a master unit, the laser oscillator serving as a slave unit, the one of the robot controllers communicating a signal sent from the corresponding one of the robot cells to the laser oscillator.

2. The laser robot system according to claim 1, wherein the plurality of robot cells share the laser oscillator.

3. The laser robot system according to claim 1, wherein the robot controllers are each allowed to be selected by switching whether a control privilege to serve as the master unit is granted.

4. The laser robot system according to claim 1 , wherein the signal to be communicated from the one of the robot controllers to the laser oscillator is a safety signal.

5. The laser robot system according to claim 4, wherein, when one of the robot controllers has detected an abnormality in its corresponding one of the robot cells, the one of the robot controllers causes laser irradiation in the corresponding one of the robot cells to stop, and causes output of the laser oscillator to stop as the one of the robot controllers communicates the safety signal sent from the corresponding one of the robot cells to the laser oscillator.

6. The laser robot system according to claim 5, wherein only a safety signal sent from one of the robot controllers, the one of the robot controllers having been granted with a control privilege to serve as the master unit, is regarded as valid.

7. The laser robot system according to claim 1 , wherein a signal communicated from one of the robot controllers to the laser oscillator represents an output command signal for laser oscillation to one of the robot cells, the one of the robot cells corresponding to the one of the robot controllers.

8. The laser robot system according to claim 7, wherein, by switching whether a control privilege to serve as the master unit is granted per a certain period of time, the robot controllers are each able to divide and use, per the certain period of time, output of laser oscillation by the laser oscillator among the plurality of robot cells.
